(19) United States
(12) Patent Application Publication
(10) Pub. No.: US 2007/0004814 A1
(43) Pub. Date: Jan. 4, 2007

(54) Process for preparing porous polymers and polymers thereof

(75) Inventors: Luigi Resconi, Ferrara (IT); Eleonora Ciaccia, Ferrara (IT); Anna Fait, Ferrara (IT)

Correspondence Address: BASELL USA INC., INTELLECTUAL PROPERTY, 912 APPLETON ROAD, ELKTON, MD, 21921, US

(73) Assignee: Basell Polyolefine GmbH, Wesseling (DE)

(21) Appl. No.: 10/553,475

(22) PCT Filed: Apr. 14, 2004
(86) PCT No.: PCT/EP04/04003

§ 371 Date: Oct. 17, 2005

Related U.S. Application Data
(60) Provisional application No. 60/469,190, filed on May 9, 2003.

(30) Foreign Application Priority Data
Apr. 17, 2003 (EP) 03101061.4

(51) Int. Cl. B29C 44/34

(52) U.S. Cl. 521/142

(57) ABSTRACT

A process for obtaining porous propylene polymers optionally containing up to 10% by mol of derived units of one or more alpha-olefins of formula CH₂═CHZ wherein Z is H or a C₂-C₁₀ alkyl radical, comprising the step of polymerizing propylene and optionally said one or more alpha olefins, under polymerization conditions, in the presence of a catalyst system comprising at least a metallocene compound, said process being characterized in that: a) the catalyst system is supported on an organic porous polymer; and b) at least part of the polymerization reaction is carried out in the presence of hydrogen.

The present invention relates to a process for preparing porous propylene polymers.

The invention further relates to the porous polymers obtainable by this process.

Porous polymers are known in the art, they have many uses, for example they can be used as adsorbents, masterbatchs, supports for catalyst systems, filter mediums or battery separators.

Processes for obtaining porous olefin polymers by using titanium-based catalyst systems are well known in the art. For example in U.S. Pat. No. 4,399,054 a polymer in spherical particle form having high flowability and bulk density is obtained. In PCT/EP02/13371 a process for increasing the porosity of a polymer is described.

More recently metallocene-based catalyst has been industrially exploited. By using metallocene-based catalyst systems it is possible to produce polymers having features different from those obtained by using titanium-based catalysts, for example polymers having narrow molecular weight distribution. In particular with metallocene-based catalysts it is possible to tune the properties of the desired polymer by changing the structure of the metallocene-compound. However a process that allows to improve the porosity of polymers obtained by using metallocene-based catalyst system it is not known. Also when metallocene-based catalyst systems are supported on porous polymer such as, for example as described in WO 95/26369, the porosity of the obtained polymer is not satisfactory, as shown in the comparative examples of the present invention. Thus it would be desirable to find a process that allows to obtain propylene polymers endowed with an enhanced porosity by using metallocene-based catalyst systems. This problem has been solved by supporting a metallocene-based catalyst system on a porous polymer, carrying out the polymerization in the presence of hydrogen and optionally by using liquid propylene as polymerization medium.

An object of the present invention is a process for obtaining porous propylene polymers optionally containing up to 10% by mol of derived units of one or more alpha-olefins of formula CH₂═CHZ wherein Z is H or a C₂-C₁₀ alkyl radical, comprising the step of polymerizing propylene and optionally said one or more alpha olefins, under polymerization conditions, in the presence of a catalyst system comprising at least a metallocene compound, said process being characterized in that:
a) the catalyst system is supported on an organic porous polymer; and
b) at least part of the polymerization reaction is carried out in the presence of hydrogen.

The polymerization reaction is preferably carried out at a temperature ranging from 20° C. to 90° C.

The polymerization process of the present invention can be carried out in liquid phase, in which the polymerization medium is liquid propylene optionally in the presence of an inert hydrocarbon solvent, and of one or more comonomer of formula CH₂═CHZ or in gas phase. Said hydrocarbon solvent can be either aromatic (such as toluene) or aliphatic (such as propane, hexane, heptane, isobutane, cyclohexane and 2,2,4-trimethylpentane).

Preferably the polymerization medium is liquid propylene. It can optionally contains minor amounts (up to 20% by weight preferably up to 10% by weight, more preferably up to 5% by weight) of an inert hydrocarbon solvent or of one or more comonomer of formula CH₂═CHZ. Said hydrocarbon solvent can be either aromatic (such as toluene) or aliphatic (such as propane, hexane, heptane, isobutane, cyclohexane and 2,2,4-trimethylpentane).

The amount of hydrogen present during the polymerization reaction is preferably more than 1 ppm; more preferably from 5 to 2000 ppm; even more preferably from 6 to 500 ppm. Hydrogen can be added either at the beginning of the polymerization reaction or it can also be added at a later stage after a prepolymerization step has been carried out.

The organic porous polymer has preferably porosity due to pores with diameter up 10 μm (100000 Å) measured to the method reported below, higher than 0.1 cc/g preferably comprised between 0.2 cc/g to 2 cc/g; more preferably from 0.3 cc/g to 1 cc/g.

In the organic porous polymer fit as support according to the process of the present invention, the total porosity due to all pores whose diameter is comprised between 0.1 μm (1000 Å) and 2 μm (20000 Å) is at least 30% of the total porosity due to all pores whose diameter is comprised between 0.02 μm (200 Å) and 10 μm (100000 Å).

Preferably the total porosity due to all pores whose diameter is comprised between 0.1 μm (1000 Å) and 2 μm (20000 Å) is at least 40% of the total porosity due to all pores whose diameter is comprised between 0.02 μm (200 Å) and 10 μm (100000 Å). More preferably the total porosity due all pores whose diameter is comprised between 0.1 μm (1000 Å) and 2 μm (20000 Å) is at least 50% of the total porosity due all pores whose diameter is comprised between 0.02 μm (200 Å) and 10 μm (100000 Å).

The organic porous polymer is preferably a porous polyolefin more preferably porous polypropylene or porous polyethylene such as those obtainable according to the process described in WO 95/26369, WO 00/08065.

The catalyst system to be supported on an organic porous polymer, according to the present invention, does not further contain silica or other inorganic support. The amount of organic porous polymer used as support is generally so low (up to 5% by weight with respect to the total polymer, preferably up to 1% by weight) that does not substantially influence the properties of the final polymer, such as melting point or molecular weight distribution.

Preferably the process for obtaining a porous propylene polymer optionally containing up to 10% by mol of derived units of one or more alpha-olefins of formula CH₂═CHZ wherein Z is H or a C₂-C₁₀ alkyl radical, of the present invention, comprises the following steps:
a) prepolymerizing propylene optionally with one or more alpha-olefins of formula CH₂═CHZ wherein Z is H or a C₂-C₁₀ alkyl radical in the presence of a catalyst system supported on an organic porous polymer, said catalyst comprising a metallocene compound; wherein the polymerization medium is liquid propylene; and
b) contacting propylene and optionally one or more alpha-olefins of formula CH₂═CHZ wherein Z is H or a C₂-C₁₀ alkyl radical under polymerization conditions in the presence of hydrogen and the prepolymerized catalyst system obtained in step a).

Preferably in step b) the polymerization medium is liquid propylene as described above.

The prepolymerized catalyst system preferably contains from 5 to 200 g of polymer per gram of catalyst system.

The prepolymerization is preferably carried out at a temperature ranging from −20° C. to 70° C.

The catalyst system containing a metallocene compound used in the process of the present invention is obtainable by reacting:
a) at least a metallocene compound;
b) at least an alumoxane or a compound able to form an alkylmetallocene cation; and
c) optionally an organo aluminum compound.

The supportation of said catalyst system is achieved by depositing the metallocene compound a) or the product of the reaction thereof with the component b), or the component b) and then the metallocene compound a) on the organic porous support. The supportation process is carried out in an inert solvent, such as hydrocarbon selected from toluene, hexane, pentane and propane and at a temperature ranging from 0° C. to 100° C., more preferably from 10° C. to 60° C. In an alternative embodiment the catalyst system is sprayed on the organic porous support.

A particularly suitable process for supporting the catalyst system is described in WO01/44319, wherein the process comprises the steps of:
(a) preparing a catalyst solution comprising a catalyst system;
(b) introducing into a contacting vessel:
   (i) a porous support material in particle form, and
   (ii) a volume of the catalyst solution not greater than the total pore volume of the porous support material introduced;
(c) discharging the material resulting from step (b) from the contacting vessel and suspending it in an inert gas flow, under such conditions that the solvent evaporates; and
(d) reintroducing at least part of the material resulting from step (c) into the contacting vessel together with another volume of the catalyst solution not greater than the total pore volume of the reintroduced material.

Metallocene compounds are transition metal compounds having at least a π-bond.

A preferred class of metallocene compounds has the following formula (I). 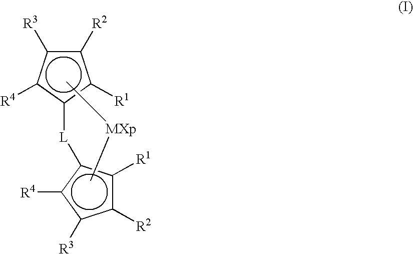
wherein
M is a transition metal belonging to group 4, 5 or to the lanthanide or actinide groups of the Periodic Table of the Elements; preferably M is zirconium, titanium or hafnium; the substituents X, equal to or different from each other, are monoanionic sigma ligands selected from the group consisting of hydrogen, halogen, R⁶, OR⁶, OCOR⁶, SR⁶, NR⁶₂ and PR⁶₂, wherein R⁶ is a linear or branched, saturated or unsaturated C₁-C₂₀ alkyl, C₃-C₂₀ cycloalkyl C₆-C₂₀ aryl, C₇-C₂₀ alkylaryl or C₇-C₂₀ arylalkyl group, optionally containing one or more Si or Ge atoms; the substituents X are preferably the same and are preferably hydrogen, halogen, R⁶ or OR⁶; wherein R⁶ is preferably a C₁-C₇ alkyl, C₆-C₁₄ aryl or C₇-C₁₄ arylalkyl group, optionally containing one or more Si or Ge atoms; more preferably, the substituents X are Cl or Me.
p is an integer equal to the oxidation state of the metal M minus 2; preferably p is 2;
L is a divalent bridging group selected from C₁-C₂₀ alkylidene, C₃-C₂₀ cycloalkylidene, C₆-C₂₀ arylidene, C₇-C₂₀ alkylarylidene, or C₇-C₂₀ arylalkylidene radicals optionally containing heteroatoms belonging to groups 13-17 of the Periodic Table of the Elements, and silylidene radical containing up to 5 silicon atoms such as SiMe₂, SiPh₂; preferably L is a divalent group (ZR⁷ₘ)ₙ; Z being C, Si, Ge, N or P, and the R⁷ groups, equal to or different from each other, being hydrogen or linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl groups or two R⁷ can form a aliphatic or aromatic C₄-C₇ ring;
more preferably L is selected from Si(CH₃)₂, SiPh₂, SiPhMe, SiMe(SiMe₃), CH₂, (CH₂)₂, (CH₂)₃ or C(CH₃)₂;
R¹, R², R³ and R⁴, equal to or different from each other, are hydrogen atoms, or linear or branched, saturated or unsaturated C₁-C₂₀-alkyl, C₃-C₂₀-Cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; or two adjacent R¹, R², R³ and R⁴ form one or more 3-7 membered ring optionally containing heteroatoms belonging to groups 13-17 of the periodic table; such as to form with the cyclopentadienyl moiety the following radicals: indenyl; mono-, di-, tri- and tetra-methyl indenyl; 2-methyl indenyl, 3-^{t}butyl-indenyl 2-isopropyli-4-phenyl indenyl, 2-methyl-4-phenyl indenyl, 2-methyl-4,5 benzo indenyl; 3-trimethylsilyl-indenyl; 4,5,6,7-tetrahydroindenyl; fluorenyl; 5,10-dihydroindeno[1,2-b]indol-10-yl; N-methyl- or N-phenyl-5,10-dihydroindeno[1,2-b]indol-10-yl; 5,6-dihydroindeno[2,1-b]indol-6-yl; N-methyl- or N-phenyl-5,6-dihydroindeno[2,1-b]indol-6-yl; azapentalene-4-yl; thiapentalene-4-yl; azapentalene-6-yl; thiapentalene-6-yl; mono-, di- and tri-methyl-azapentalene-yl, 2,5-dimethyl-cyclopenta[1,2-b:4,3-b′]-dithiophene; said rings can be substituted by one or more hydrocarbon radicals containing from 1 to 20 carbon atoms ring optionally containing heteroatoms belonging to groups 13-17 of the periodic table.

Non limiting examples of compounds belonging to formula (I) are the following compounds (when possible in either their meso or racemic isomers, or mixtures thereof):
dimethylsilanediylbis(indenyl)zirconium dichloride,
dimethylsilanediylbis(2-methyl-4-phenylindenyl)zirconium dichloride,
dimethylsilanediylbis(4-naphthylindenyl)zirconium dichloride,
dimethylsilanediylbis(2-methylindenyl)zirconium dichloride,
dimethylsilanediylbis(2-methyl-4-isopropylindenyl)zirconium dichloride,
dimethylsilanediylbis(2,4-dimethylindenyl)zirconium dichloride,
dimethylsilanediylbis(2-methyl-4,5-benzoindenyl)zirconium dichloride,
dimethylsilanediylbis(2,4,7-trimethylindenyl)zirconium dichloride,
dimethylsilanediylbis(2,4,6-trimethylindenyl)zirconium dichloride,
dimethylsilanediylbis(2,5,6-trimethylindenyl)zirconium dichloride,
dimethylsilanediylbis(2-isopropyl-4-(4′-tert-butyl)-pheny-Indenyl)(2,7-Methyl-4-(4′-tert-butyl)-Phenyl-Indenyl)-zirconium dichloride,
dimethylsilanediylbis(2-isopropyl-4-(4′-tert-butyl)-pheny-Indenyl)(2-Methyl-4-(4′-tert-butyl)-Phenyl-Indenyl)-zirconium dichloride,
dimethylsilanediylbis(2-isopropyl-4-pheny-Indenyl)(2-Methyl-4-Phenyl-Indenyl)-zirconium dichloride,
methyl(phenyl)silanediylbis(2-methyl-4,6-diisopropylindenyl)-zirconium dichloride,
methyl(phenyl)silanediylbis(2-methyl-4-isopropylindenyl)-zirconium dichloride,
1,2-ethylenebis(indenyl)zirconium dichloride,
1,2-ethylenebis(4,7-dimethylindenyl)zirconium dichloride,
1,2-ethylenebis(2-methyl-4-phenylindenyl)zirconium dichloride,
1,2-ethylenebis(2-methyl-4,6-diisopropylindenyl)zirconium dichloride,
1,2-ethylenebis(2-methyl-4,5-benzoindenyl)zirconium dichloride,
dimethylsilandiyl-1-(2-methyl-indenyl)-7-(2,5-dimethylcyclopentadienyl-[1,2-b:4,3-b′]dithiophene)hafnium dichloride;
dimethylsilanediyl(3-tert-butyl-cyclopentadienyl)(9-fluorenyl)zirconium dichloride,
dimethylsilandiylbis-6-(3-methylcyclopentadienyl-[1,2-b]-thiophene) dichloride;
dimethylsilandiylbis-6-(4-methylcyclopentadienyl-[1,2-b]-thiophene)zirconium dichloride;
dimethylsilandiylbis-6-(4 isopropylcyclopentadienyl-[1,2-b]-thiophene)zirconium dichloride;
dimethylsilandiylbis-6-(4-ter-butylcyclopentadienyl-[1,2-b]-thiophene)zirconium dichloride;
dimethylsilandiylbis-(3-isopropylcyclopentadienyl-[1,2-b]-thiophene)zirconium dichloride;
dimethylsilandiylbis-6-(3-phenylcyclopentadienyl-[1,2-b]-thiophene)zirconium dichloride;
dimethylsilandiylbis-6-(2,5-chloride-3-phenylcyclopentadienyl-[1,2-b]-thiophene)zirconium di methyl;
dimethylsilandiylbis-6-[2,5-dichloride-3-(2-methylphenyl)cyclopentadienyl-[1,2-b]-thiophene]zirconium dichloride;
dimethylsilandiylbis-6-[2,5-dichloride-3-(2,4,6-trimethylphenyl)cyclopentadienyl-[1,2-b]-thiophene]zirconium dichloride;
dimethylsilandiylbis-6-[2,5-dichloride-3-mesitylenecyclopentadienyl-[1,2-b]-thiophene]zirconium dichloride;
dimethylsilandiylbis-6-(2,4,5-trimethyl-3-phenylcyclopentadienyl-[1,2-b]-thiophene)zirconium dichloride;
dimethylsilandiylbis-6-(2,5-diethyl-3-phenylcyclopentadienyl-[1,2-b]-thiophene)zirconium dichloride;
dimethylsilandiylbis-6-(2,5-diisopropyl-3-phenylcyclopentadienyl-[1,2-b]-thiophene)zirconium dichloride;
dimethylsilandiylbis-6-(2,5-diter-butyl-3-phenylcyclopentadienyl-[1,2-b]-thiophene)zirconium dichloride;
dimethylsilandiylbis-6-(2,5-ditrimethylsilyl-3-phenylcyclopentadienyl-[1,2-b]-thiophene)zirconium dichloride;
dimethylsilandiylbis-6-(3-methylcyclopentadienyl-[1,2-b]-silole)zirconium dichloride;
dimethylsilandiylbis-6-(3-isopropylcyclopentadienyl-[1,2-b]-silole)zirconium dichloride;
dimethylsilandiylbis-6-(3-phenylcyclopentadienyl-[1,2-b]-silole)zirconium dichloride;
dimethylsilandiylbis-6-(2,5-dichloride-3-phenylcyclopentadienyl-[1,2-b]-silole)zirconium dichloride;
dimethylsilandiylbis-6-[2,5-dichloride-3-(2-methylphenyl)cyclopentadienyl-[1,2-b]-silole]zirconium dichloride;
dimethylsilandiylbis-6-[2,5-dichloride-3-2,4,6-trimethylphenyl)cyclopentadienyl-[1,2-b]-silole]zirconium dichloride;
dimethylsilandiylbis-6-[2,5-dichloride-3-mesitylenecyclopentadienyl-[1,2-b]-silole]zirconium dichloride;
dimethylsilandiylbis-6-(2,4,5-trimethyl-3-phenylcyclopentadienyl-[1,2-b]-silole)zirconium dichloride;
   as well as the corresponding dimethyl, hydrochloro and dihydro and η⁴⁻butadiene compounds.

Suitable metallocene complexes belonging to formula (I) are described in WO 98/22486, WO 99/58539 WO 99/24446, U.S. Pat. No. 5,556,928, WO 96/22995, EP485822, EP-485820, U.S. Pat. No. 5,324,800, EP-A-0 129 368, U.S. Pat. No. 5,145,819, EP-A-0 485 823, WO 01/47939, WO 01/44318 and PCT/EP02/13552.

Preferred metallocene compounds have formula (II): 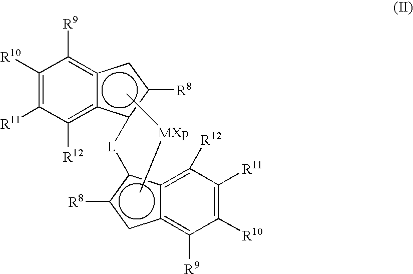
wherein M, X, L and p have been described above;
R⁸, equal to or different from each other, are linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; preferably R⁸, equal to or different from each other, is a methyl, ethyl or isopropyl radical;
R⁹, R¹⁰, R¹¹ and R¹², equal to or different from each other, are hydrogen atoms, linear or branched, saturated or unsaturated C₁-C₂₀-alkyl, C₃-C₂₀-cycloalkyl, C₆-C₂₀-aryl C₇-C₂₀-alkylaryl, or C₇-C₂₀-arylalkyl radicals, optionally containing one or more heteroatoms belonging to groups 13-17 of the Periodic Table of the Elements; or they can join to form a condensed 4-7 membered ring such as a benzene ring to form with the indenyl radical a benzoindenyl moiety;

Preferably R¹⁰ is hydrogen; preferably R⁹ is a C₁-C₂₀-alkyl, a C₆-C₂₀-aryl or a C₇-C₂₀-arylalkyl radical; more preferably R⁹ is a C₆-C₂₀-aryl or a C₇-C₂₀-arylalkyl radical.

Preferably R¹⁰ and R¹¹ are hydrogen, C₁-C₂₀-alkyl, a C₆-C₂₀-aryl or a C₇-C₂₀-arylalkyl radical; more preferably R¹¹ is hydrogen or a methyl radical.

Alumoxanes used as component b) can be obtained by reacting water with an organo-aluminium compound of formula HⱼAlU₃₋ⱼ or HⱼAl₂U₆₋ⱼ, where the U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radicals, optionally containing silicon or germanium atoms, with the proviso that at least one U is different from halogen, and j ranges from 0 to 1, being also a non-integer number. In this reaction the molar ratio of Al/water is preferably comprised between 1:1 and 100:1.

The molar ratio between aluminium and the metal of the metallocene is generally comprised between about 10:1 and about 30000:1, preferably between about 100:1 and about 5000:1.

The alumoxanes used in the catalyst according to the invention are considered to be linear, branched or cyclic compounds containing at least one group of the type: 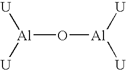
wherein the substituents U, same or different, are defined above.

In particular, alumoxanes of the formula: 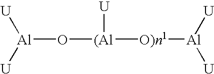
can be used in the case of linear compounds, wherein n¹ is 0 or an integer of from 1 to 40 and the substituents U are defined as above; or alumoxanes of the formula: 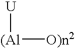
can be used in the case of cyclic compounds, wherein n² is an integer from 2 to 40 and the U substituents are defined as above.

Examples of alumoxanes suitable for use according to the present invention are methylalumoxane (MAO), tetra-isobutyl)alumoxane (TIBAO), tetra-2,4,4-trimethyl-pentyl)alumoxane (TIOAO), tetra-(2,3 dimethylbutyl)alumoxane (TDMBAO) and tetra-(2,3,3-trimethylbutyl)alumoxane (TTMBAO).

Particularly interesting cocatalysts are those described in WO 99/21899 and in WO01/21674 in which the alkyl and aryl groups have specific branched patterns.

Non-limiting examples of aluminium compounds that can be reacted with water to give suitable alumoxanes (b), described in WO 99/21899 and WO01/21674, are: tris(2,3,3-trimethyl-butyl)aluminium, tris(2,3-dimethyl-hexyl)aluminium, tris(2,3-dimethyl-butyl)aluminium, tris(2,3-dimethyl-pentyl)aluminium, tris(2,3-dimethyl-heptyl)aluminium, tris(2-methyl-3-ethyl-pentyl)aluminium, tris(2-methyl-3-ethyl-hexyl)aluminium, tris(2-methyl-3-ethyl-heptyl)aluminium, tris(2-methyl-3-propyl-hexyl)aluminium, tris(2-ethyl-3-methyl-butyl)aluminium, tris(2-ethyl-3-methyl-pentyl)aluminium, tris(2,3-diethyl-pentyl)aluminium, tris(2-propyl-3-methyl-butyl)aluminium, tris(2-isopropyl-3-methyl-butyl)aluminium, tris(2-isobutyl-3-methyl-pentyl)aluminium, tris(2,3,3-trimethyl-pentyl)aluminium, tris(2,3,3-trimethyl-hexyl)aluminium, tris(2-ethyl-3,3-dimethyl-butyl)aluminium, tris(2-ethyl-3,3-dimethyl-pentyl)aluminium, tris(2-isopropyl-3,3-dimethyl-butyl)aluminium, tris(2-trimethylsilyl-propyl)aluminium, tris(2-methyl-3-phenyl-butyl)aluminium, tris(2-ethyl-3-phenyl-butyl)aluminium, tris(2,3 diethyl-3-phenyl-butyl)aluminium, tris(2-phenyl-propyl)aluminium, tris[2-(4-fluoro-phenyl)-propyl]aluminium, tris[2-(4-chloro-phenyl)-propyl]aluminium, tris[2-(3-isopropyl-phenyl)-propyl]aluminium, tris(2-phenyl-butyl)aluminium, tris(3-methyl-2-phenyl-butyl)aluminium, tris(2-phenyl-pentyl)aluminium, tris[2-(pentafluorophenyl)-propyl]aluminium, tris[2,2-diphenyl-ethyl]aluminium and tris[2-phenyl-2-methyl-propyl]aluminium, as well as the corresponding compounds wherein one of the hydrocarbyl groups is replaced with a hydrogen atom, and those wherein one or two of the hydrocarbyl groups are replaced with an isobutyl group.

Amongst the above aluminium compounds, trimethylaluminium (TMA), triisobutylaluminium (TIBA), tris(2,4,4-trimethyl-pentyl)aluminium (TIOA), tris(2,3-dimethylbutyl)aluminium (TDMBA) and tris(2,3,3-trimethylbutyl)aluminium (TTMBA) are preferred.

Non-limiting examples of compounds able to form an alkylmetallocene cation are compounds of formula D⁺E⁻, wherein D⁺ is a Brønsted acid, able to donate a proton and to react irreversibly with a substituent X of the metallocene of formula (I) and E⁻ is a compatible anion, which is able to stabilize the active catalytic species originating from the reaction of the two compounds, and which is sufficiently labile to be removed by an olefinic monomer. Preferably, the anion E⁻ comprises one or more boron atoms. More preferably, the anion E⁻ is an anion of the formula BAr₄⁽⁻⁾ wherein the substituents Ar which can be identical or different are aryl radicals such as phenyl, pentafluorophenyl or bis(trifluoromethyl)phenyl. Tetrakis-pentafluorophenyl borate is particularly preferred compound, as described in WO 91/02012. Moreover, compounds of formula BAr₃ can be conveniently used. Compounds of this type are described, for example, in the International patent application WO 92/00333. Other examples of compounds able to form an alkylmetallocene cation are compounds of formula BAr₃P wherein P is a substituted or unsubstituted pyrrol radical. These compounds are described in WO01/62764. Compounds containing boron atoms can be conveniently supported according to the description of DE-A-19962814 and DE-A-19962910. All these compounds containing boron atoms can be used in a molar ratio between boron and the metal of the metallocene comprised between about 1:1 and about 10:1; preferably 1:1 and 2.1; more preferably about 1:1.

Non limiting examples of compounds of formula D⁺E⁻ are:
Triethylammoniumtetra(phenyl)borate,
Tributylammoniumtetra(phenyl)borate,
Trimethylammoniumtetra(tolyl)borate,
Tributylammoniumtetra(tolyl)borate,
Tributylammoniumtetra(pentafluorophenyl)borate,
Tributylammoniumtetra(pentafluorophenyl)aluminate,
Tripropylammoniumtetra(dimethylphenyl)borate,
Tributylammoniumtetra(trifluoromethylphenyl)borate,
Tributylammoniumtetra(4-fluorophenyl)borate,
N,N-Dimethylbenzylammonium-tetrakispentafluorophenylborate,
N,N-Dimethylhexylamonium-tetrakispentafluorophenylborate,
N,N-Dimethylaniliniumtetra(phenyl)borate,
N,N-Diethylaniliumtetra(phenyl)borate,
N,N-Diiethylaniliniumtetrakis(pentafluorophenyl)borate,
N,N-Dimethylaniliniumtetrakis(pentafluorophenyl)aluminate,
N,N-Dimethylbenzylammonium-tetrakispentafluorophenylborate,
N,N-Dimethylhexylamonium-tetrakispentafluorophenylborate,
Di(propyl)ammoniumtetrakis(pentafluorophenyl)borate,
Di(cyclohexyl)ammoniumtetrakis(pentafluorophenyl)borate,
Triphenylphosphoniumtetrakis(phenyl)borate,
Triethylphosphoniumtetrakis(phenyl)borate,
Diphenylphosphoniumtetrakis(phenyl)borate,
Tri(methylphenyl)phosphoniumtetrakis(phenyl)borate,
Tri(dimethylphenyl)phosphoniumtetrakis(phenyl)borate,
Triphenylcarbeniumtetrakis(pentafluorophenyl)borate,
Triphenylcarbeniumtetrakis(pentafluorophenyl)aluminate,
Triphenylcarbeniumtetrakis(phenyl)aluminate,
Ferroceniumtetrakis(pentafluorophenyl)borate,
Ferroceniumtetrakis(pentafluorophenyl)aluminate.
Triphenylcarbeniumtetrakis(pentafluorophenyl)borate, and
N,N-Dimethylaniliniumtetrakis(pentafluorophenyl)borate.

Organic aluminum compounds used as compound c) are those of formula HⱼAlU₃₋ⱼ or HⱼAl₂U₆₋ⱼ as described above.

The porous propylene polymer optionally containing up to 10% by mol; preferably up to 5% by mol of derived units of one or more alpha-olefins of formula CH₂═CHZ wherein Z is H or a C₂-C₁₀ alkyl radical obtained with the process of the present invention, preferably has a melting point >100° C., more preferably >120° C.

Thus a further object of the present invention is propylene polymer particles optionally containing up to 10% by mol of derived units of one or more alpha-olefins of formula CH₂═CHZ wherein Z is H or a C₂-C₁₀ alkyl radical having the following features:
melting point >100° C.; preferably a melting point >120° C.;
total porosity expressed as percentage of voids, % V/V₁>15; preferably % V/V₁>20; more preferably % V/V₁>30; and
molecular weight distribution Mw/Mn<4; preferably Mw/Mn<3.

Examples of said alpha olefins that can be used in the process of the present invention are ethylene, 1-butene, 1-pentene, 4-methyl-1-pentene, 1-hexene, 1-octene, 4,6-dimethyl-1-heptene, 1-decene, dodecene, 1-tetradecene, 1-hexadecene, 1-octadecene and 1-eicosene. Preferred comonomers are ethylene and 1-butene.

The molecular weight distribution can be varied by using mixtures of different metallocene compounds or by carrying out the polymerization in several stages which differ as to the polymerization temperature and/or the concentrations of the molecular weight regulators and/or the monomers concentration.

The molecular weight (LV) of the obtained polymer preferably ranges from 0.5 to 20.

The following examples are given to illustrate and not to limit the invention

### EXPERIMENTAL SECTION

rac-dimethylsilylbis(2-methyl-4-(para-tert-butylphenyl)-indenyl)-zirconium dichloride (rac-Me₂Si(2-Me-4(4tBuPh)Ind)₂ZrCl₂) was prepared according to WO 98/40331 (example 65).

Intrinsic viscosity (I.V.) was measured in decahidronaftalene (DHN) at 135° C.

Porosity (mercury) is determined by immersing a known quantity of the sample in a known quantity of mercury inside a dilatometer and gradually hydraulically increasing the pressure of the mercury. The pressure of introduction of the mercury in the pores is in function of the diameter of the same. The measurement was carried out using a porosimeter “Porosimeter 2000 Series” (Carlo Erba). The total porosity was calculated from the volume decrease of the mercury and the values of the pressure applied.

The porosity expressed as percentage of voids (% V/V₁) is determined by absorption of mercury under pressure. The volume of mercury absorbed corresponds to the volume of the pores. For this determination, a calibrated dilatometer (diameter 3 mm) CD3 (Carlo Erba) connected to a reservoir of mercury and to a high-vacuum pump (1×10⁻² mbar) is used. A weighed amount of sample (about 0.5 g) is placed in the dilatometer. The apparatus is then placed under high vacuum (<0.1 mm Hg) and is maintained in these conditions for 10 minutes. The dilatometer is then connected to the mercury reservoir and the mercury is allowed to flow slowly into it until it reaches the level marked on the dilatometer at a height of 10 cm. The valve that connects the dilatometer to the vacuum pump is closed and the apparatus is pressurized with nitrogen (2.5 Kg/cm²). Under the effect of the pressure, the mercury penetrates into the pores and the level goes down according to the porosity of the material. Once the level at which the mercury has stabilized has been measured on the dilatometer, the volume of the pores is calculated from the equation V=R2πΔH, where R is the radius of the dilatometer and ΔH is the difference in cm between the initial and the final levels of the mercury in the dilatometer. By weighting the dilatometer, dilatometer+mercury, dilatometer+mercury+sample, the value of the apparent volume V₁ of the sample prior to penetration of the pores can be calculated. The volume of the sample is given by:
V₁=[P₁−(P₂−P)]/D
P is the weight of the sample in grams, P₁ is the weight of the dilameter+mercury in grams, P₂ is the weight of the dilatometer+mercury+sample in grams, D is the density of mercury (at 25° C.=13,546 g/cc). The percentage porosity is given by the relation:
X=(100V)/V₁.
The pore distribution curve, and the average pore size are directly calculated from the integral pore distribution curve which is function of the volume reduction of the mercury and applied pressure values (all these data are provided and elaborated by the porosimeter associated computer which is equipped with a “MILESTONE 200/2.04” program by C. Erba.

Bulk density (PBD) was measured according to DIN-53194.

Porous Polymeric Support

Polyethylene prepolymer (support A) was produced according to the procedure described in example 1 of WO 95/26369, under the following conditions: polymerisation temperature 0° C., AliBu₃ (AliBu₃/ZN catalyst=1 (w/w)), 1.5 bar-g of ethylene (conversion of 40 g_{PE}/g_{cat}). Characterization data of the polymer are reported in table 1

Polypropylene prepolymer (support B) was produced according to the procedure described in the example 1 of WO 00/08065, under the following conditions: polymerisation temperature 20° C., AliBu₃ (AliBu₃/ZN catalyst=1 (w/w)), propylene flow=1 kg/h for 2 h, then 5 kg/h for 6 h (conversion 40 g_{PP}/g_{cat}). Characterization data of the polymer are reported in table 1

TABLE 1

| | | % of pores having diameter | |
|---|---|---|---|
| | | comprised between 0.1 μm | Porosity |
| support | PBD | (1000 Å) and 2 μm (20000 Å) | cc/g |
| A | 0.286 | 70.57 | 0.566 |
| B | 0.262 | 64.51 | 0.663 |

Preparation of the Supported Catalyst Systems
Catalyst System 1

1700 g of support A were treated with H₂O dispersed in hexane in order to deactivate the MgCl₂/Ti-based catalyst, then dried in a flow of nitrogen. The support is contacted with 600 mL of a MAO (methyl alumoxane) solution (Albemarle 100 g/L in toluene) to scavenge impurities and residual water.

19.7 g of rac-Me₂Si(2-Me-4(4tBuPh)Ind)₂ZrCl₂ are added in 1.8 L of MAO solution (30% w/w in toluene). The catalytic mixture obtained, was diluted with 1 L of purified toluene in order to reach the volume necessary for a homogeneous impregnation. The so obtained catalytic mixture is impregnated on support A (treated as described above) according to the procedure described in WO 01/44319.

The obtained supported catalyst system contains 9.2% w of Aluminium and 0.08% w of Zirconium.

Catalyst System 2

1870 g of support A described above, were treated with H₂O dispersed in hexane in order to deactivate the MgCl₂/Ti-based catalyst, then dried in a flow of nitrogen. The support is contacted with 200 mL of a MAO solution (30% w in toluene) to scavenge impurities and residual water.

28.6 g of rac-Me₂Si(2-Me-4(4tBuPh)Ind)₂ZrCl₂ were added in 1.65 L of MAO solution (30% w/w in toluene). The catalytic mixture obtained, was diluted with 650 mL of purified toluene in order to reach the volume necessary for a homogeneous impregnation. The so obtained catalytic mixture is impregnated on support A, (treated as described above) according to the procedure described in WO 01/44319.

The obtained supported catalyst system contains 8% w of Aluminium and 0.11% w of Zirconium.

Catalyst System 3

5.5 g of support A described above, were treated with H₂O dispersed in hexane in order to deactivate the MgCl₂/Ti-based catalyst, then dried in a flow of nitrogen. The support is contacted with 0.5 mL of a MAO solution (30% w in toluene) diluited with 1.5 ml of toluene to scavenge impurities and residual water.

The catalytic complex was prepared by adding 32 mg of metallocene rac-Me₂Si(2-Me-4(4tBuPh)Ind)₂ZrCl₂ in 5 mL of MAO solution (30% w/w in toluene).

The so obtained catalytic mixture is impregnated on support A (treated as described above)-according to the procedure described in WO 01/44319.

The obtained supported catalyst system contains 9.2% w of Aluminium and 0.041% w of Zirconium.

Catalyst System 4

90 g of support B described above, were treated with H₂O dispersed in hexane in order to deactivate the MgCl₂/Ti-based catalyst, then dried in a flow of nitrogen. Then it were loaded into the contacting vessel; mechanically stirred, under inert atmosphere and were contacted with 9 mL of a MAO solution (30% w in toluene), diluted with 21 mL of toluene, to scavenge impurities and residual water.

0.67 g of metallocene rac-Me₂Si(2-Me-4(4tBuPh)Ind)₂ZrCl₂ were added to 81 mL of MAO solution (30% w/w in toluene). The so obtained catalytic mixture obtained, was diluted with 60 mL of purified toluene and contacted with support B according to the procedure described in WO 01/44319.

After the supportation an off line ethylene prepolymerization was carried out with ethylene up to a polymerisation extent of 20% wt, in the following conditions: 35° C., 0.55-0.65 bar ethylene partial pressure, polymerization time 60 minutes.

The prepolymerized catalyst contains a 7.1% w of Aluminium and 0.04% w of Zirconium.

Catalyst System 5 (Comparative)

3 kg of silica (Sylopol 948™) is loaded in a process filter whose filter plate points upward, and suspended in 15 L of toluene. While stirring 7 L of a 30% strength by weight MAO solution are metered in at such a rate that the internal temperature does not exceed 35° C. After stirring for another 1 hour at a low stirrer speed, the process filter is turned that its filtration plate points downwards, the suspension is filtered, firstly under atmospheric pressure and then using 3 bar of nitrogen pressure. In parallel to the treatment of the support material, 2.0 L of 30% strength by weight MAO solution and 92.3 g of rac-dimethylsilylbis(2-methyl-4-(para-tert-butylphenyl)-indenyl)-zirconium dichloride are placed in a reaction vessel, the solution is stirred for 1 hour and allowed to settle for a further 30 minutes. The solution is subsequently added to the pretreated support material with the outlet closed. After addition is complete, the outlet is opened and the filtrate is allowed to drain. When no more runs off, the outlet is closed, the filter cake is stirred for 15 minutes and allowed to rest for 1 hour. A nitrogen pressure of 3 bar is subsequently applied with the outlet open. 15 L of isododecane are added to the remaining solid, the mixture is stirred for 15 minutes and filtered. The washing step is repeated, and the solid is subsequently pressed dry by means of a nitrogen pressure of 3 bar. For use in the polymerization, the total amount of the catalyst is resuspended in 15 L of isododecane.

The catalyst system contains 0.16% w of Zirconium.

### POLYMERIZATION EXAMPLES 1-7 And Comparative Examples 8-10

All polymerization tests were carried out in a 2.490 L stainless steel Reactor, operated by a Yokogawa system, and equipped with a paddle stirrer, with stirring rate of 300-400 RPM, a stainless steel vial for catalyst injection, and a look-through glass window.

The reactor is purified by washing with 1 L hexane containing 3 mL of trimethylaluminum 10% (1M), stirring 1 h at 70° C., and then discharging the solution through the bottom valve under N₂ pressure. The reactor temperature is lowered to 30° C., and the reactor pressure to 0.5 bar-g. Then the scavenger (4 mL 1M TEA in hexane) is added under a stream of propylene, and 700 g of liquid propylene is added. The amount of supported catalyst indicated in table 2 is added to the reactor through a stainless steel vial. For catalyst systems 1-5, the dry powder is loaded into the steel vial under N₂ stream, injected into the reactor by N₂ overpressure, then the vial rinsed with 3-4 mL of hexanes into the reactor, again with N₂ overpressure. For catalyst system 6, the powder is added as a slurry in hexanes.

The homopolymer is produced in liquid monomer, by first a prepolymerization at 30° C. for 10 min, then adding the required amount of hydrogen, then the temperature is raised to the polymerizing temperature indicated in table 2 in 10 minutes. The polymerization is carried out for a time indicated in table 2 then it is stopped by adding CO and venting the monomers. The reactor is cooled, purged with N₂, opened to inspect fouling, and the polymer is collected and dried in a vacuum oven at 60° C. for 1 hour. The polymerization conditions and the characterization data of the obtained polymers are reported in Table 2.

TABLE 2

| | | | | mg | | | | H₂ | | total |
|---|---|---|---|---|---|---|---|---|---|---|
| | catalyst | MAO/Zr | Zr | of supp. | Tₚ | t_{P} | H₂ | % wt | H₂ | porosity |
| Ex | system | molar | % wt | catalyst | ° C. | min. | mL | liqph | ppm | % V/V₁ |
| 1* | 1 | 398 | 0.08 | 115 | 70 | 60 | 0 | 0 | 0 | 10.4 |
| 2 | 1 | 398 | 0.08 | 163 | 70 | 35 | 100 | 0.00067 | 6.7 | 34.9 |
| 3 | 2 | 246 | 0.11 | 105 | 70 | 50 | 100 | 0.00067 | 6.7 | 21.4 |
| 4 | 2 | 246 | 0.11 | 95 | 70 | 40 | 500 | 0.0034 | 34 | 33.4 |
| 5 | 3 | 756 | 0.04 | 153 | 70 | 60 | 100 | 0.00067 | 6.7 | 22.2 |
| 6 | 4 | 570 | 0.04 | 80 | 70 | 40 | 500 | 0.0034 | 34 | 23.1 |
| 7 | 4 | 570 | 0.04 | 84 | 70 | 40 | 2000 | 0.0134 | 134 | 22 |
| 8* | 5 | 353 | 0.16 | 132 | 70 | 60 | 0 | 0 | 0 | 6.4 |
| 9* | 5 | 353 | 0.16 | 138 | 70 | 60 | 500 | 0.0034 | 34 | 7.6 |
| 10* | 5 | 353 | 0.16 | 99 | 70 | 60 | 1000 | 0.0067 | 67 | 7 |

| | | Activity | | | | | | |
|---|---|---|---|---|---|---|---|---|
| | yield | kg_{PP}/ | kg_{PP}/ | | PBD | IV_{(DHN)} | | Tₘ |
| Ex | g | g_{cat}/h | g_{Zr}/h | morphology | g/cc | dl/g | Mw/Mn | ° C. |
| 1 | 210 | 1.83 | 2341 | spherical, no | 0.355 | n.a. | n.a. | 149.7 |
| | | | | fouling, no | | | | |
| | | | | powder | | | | |
| 2 | 315 | 3.31 | 4247 | spherical, no | 0.346 | 4.17 | 2.8 | 149 |
| | | | | fouling, no | | | | |
| | | | | powder | | | | |
| 3 | 290 | 3.31 | 3013 | spherical, no | 0.330 | 4.47 | 2.8 | 151 |
| | | | | fouling, no | | | | |
| | | | | powder | | | | |
| 4 | 275 | 4.34 | 3947 | spherical, no | 0.314 | 3.55 | 2.9 | 150.5 |
| | | | | fouling, no | | | | |
| | | | | powder | | | | |
| 5 | 275 | 1.80 | 4384 | spherical, no | 0.332 | 4.27 | 2.6 | 151 |
| | | | | fouling, no | | | | |
| | | | | powder | | | | |
| 6 | 167 | 3.13 | 7455 | spherical, no | 0.227 | 3.35 | 2.7 | n.a. |
| | | | | fouling, no | | | | |
| | | | | powder | | | | |
| 7 | 205 | 3.66 | 8716 | spherical, no | 0.224 | 0.72 | 2.3 | n.a. |
| | | | | fouling, no | | | | |
| | | | | powder | | | | |
| 8* | 209 | 1.58 | 990 | spherical small, | 0.452 | 4.32 | n.a. | 150.5 |
| 9* | 271 | 1.96 | 1227 | spherical small, | 0.382 | 3.28 | n.a. | 151 |
| | | | | powder | | | | |
| 10* | 285 | 2.88 | 1799 | spherical small, | 0.372 | 2.43 | n.a. | 150.7 |
| | | | | powder | | | | |

n.a. not available
*comparative

1. A process for obtaining porous propylene polymers optionally containing up to 10% by mol of derived units of at least one alpha-olefin of formula CH₂═CHZ wherein Z is H or a C₂-C₁₀ alkyl radical, comprising the step of polymerizing, in a polymerization medium, propylene and optionally said at least one alpha-olefin, under polymerization conditions, in the presence of a catalyst system comprising at least a metallocene compound wherein:
a) the catalyst system is supported on an organic porous polymer; and
b) at least part of the polymerization reaction is carried out in the presence of hydrogen.

2. The process according to claim 1 wherein the polymerization medium is liquid propylene optionally containing minor amounts of an inert hydrocarbon solvent or at least one comonomer of formula CH₂═CHZ.

3. A process for obtaining a porous propylene polymer optionally containing up to 10% by mol of derived units of at least one alpha-olefin of formula CH₂═CHZ wherein Z is H or a C₂-C₁₀ alkyl radical, comprising the following steps:
a) prepolymerizing in a first polymerization medium propylene optionally with at least one alpha-olefin of formula CH₂═CHZ wherein Z is H or a C₂-C₁₀ alkyl radical in the presence of a catalyst system supported on an organic porous polymer, said catalyst comprising a metallocene compound; wherein the first polymerization medium is liquid propylene; and
b) contacting propylene and optionally at least one alpha-olefin of formula CH₂═CHZ wherein Z is H or a C₂-C₁₀ alkyl radical under polymerization conditions in the presence of hydrogen and the prepolymerized catalyst system obtained in step a), in a second polymerization medium.

4. The process according to claim 3 wherein the second polymerization medium is liquid propylene optionally containing minor amounts of an inert hydrocarbon solvent or at least one comonomer of formula CH₂═CHZ.

5. The process according to claim 1 wherein the organic porous polymer has porosity due to pores with diameter up 10 μm (100000 Å) higher than 0.1 cc/g.

6. The process according to claim 1 wherein in the organic porous polymer a total porosity due to all pores whose diameter is comprised between 0.1 μm (1000 Å) and 2 μm (20000 Å) is at least 30% of a total porosity due to of all pores whose diameter is comprised between 0.02 μm (200 Å) and 10 μm (100000 Å).

7. The process according to claim 1 wherein an amount of hydrogen present during the polymerization reaction is more than 1 ppm.

8. The process according to claim 1 wherein the catalyst system containing the metallocene compound is obtained by reacting:
a) the metallocene compound;
b) at least an alumoxane or a compound that forms an alkylmetallocene cation; and
c) optionally an organo aluminum compound.

9. The process according to claim 8 wherein the catalyst system is supported on an organic porous polymeric support according to a process comprising the following steps:
(a) preparing a catalyst solution comprising the catalyst system and a solvent;
(b) introducing into a contacting vessel:
(i) a porous support material in particle form having a total pore volume, and
(ii) a first volume of the catalyst solution not greater than the total pore volume of the porous support material introduced;
(c) discharging the material resulting from step (b) from the contacting vessel and suspending it in an inert gas flow, under such conditions that the solvent evaporates; and
(d) reintroducing at least part of the material resulting from step (c) into the contacting vessel together with a second volume of the catalyst solution not greater than the total pore volume of the reintroduced material.

10. The process according to claim 1 wherein the metallocene compounds belong to formula (I): 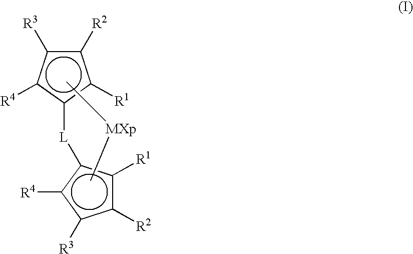
wherein
M is a transition metal belonging to group 4, 5 or to the lanthanide or actinide groups of the Periodic Table of the Elements;
the substituents X, equal to or different from each other, are monoanionic sigma ligands selected from the group consisting of hydrogen, halogen, R⁶, OR⁶, OCOR⁶, SR⁶, NR⁶₂ and PR⁶₂, wherein R⁶ is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl group, optionally containing at least one Si and Ge atom;
p is an integer equal to the oxidation state of the metal M minus 2;
L is a divalent bridging group selected from C₁-C₂₀ alkylidene, C₃-C₂₀ cycloalkylidene, C₆-C₂₀ arylidene, C₇-C₂₀ alkylarylidene, or C₇-C₂₀ arylalkylidene radicals optionally containing heteroatoms belonging to groups 13-17 of the Periodic Table of the Elements, and silylidene radical containing up to 5 silicon atoms;
R¹, R², R³ and R⁴, equal to or different from each other, are hydrogen atoms, or linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing at least one heteroatom belonging to groups 13-17 of the Periodic Table of the Elements; or two adjacent R¹, R², R³ and R⁴ form at least one 3-7 membered ring optionally containing heteroatoms belonging to groups 13-17 of the periodic table; said rings can be substituted by at least one hydrocarbon radical containing from 1 to 20 carbon atoms ring optionally containing heteroatoms belonging to groups 13-17 of the periodic table.

11. The process according to claim 10 wherein the metallocene compounds belong to formula (II): 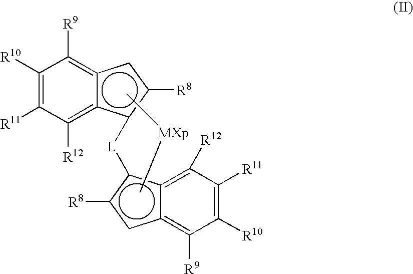
wherein
R⁸, equal to or different from each other, are linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing at least one heteroatom belonging to groups 13-17 of the Periodic Table of the Elements;
R⁹, R¹⁰, R¹¹ and R¹², equal to or different from each other, are hydrogen atoms, linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing at least one heteroatom belonging to groups 13-17 of the Periodic Table of the Elements; or they can join to form a condensed 4-7 membered ring.

12. A propylene polymer optionally containing up to 10% by mol of derived units of at least one alpha-olefin of formula CH₂═CHZ wherein Z is H or a C₂-C₁₀ alkyl radical having the following features:
(i) a melting point >100° C.;
(ii) a total porosity expressed as percentage of voids % V/V₁>15; and
(iii) a molecular weight distribution Mw/Mn<4.
